(19) United States
(12) Patent Application Publication
(10) Pub. No.: US 2019/0334842 A1
(43) Pub. Date: Oct. 31, 2019

(54) INFORMATION PROCESSING SYSTEM

(71) Applicant: SUGAR INC., Tokyo (JP)

(72) Inventor: Takeru SATO, Shibuya-ku, Tokyo (JP)

(21) Appl. No.: 16/342,623

(22) PCT Filed: Oct. 18, 2017
(86) PCT No.: PCT/JP2017/037705

§ 371 Date: Jun. 25, 2019

(30) Foreign Application Priority Data
Oct. 21, 2016 (JP) 2016-206772
Aug. 3, 2017 (JP) PCT/JP2017/028313

(51) Int. Cl. H04L 12/58; H04L 29/06

(52) U.S. Cl. CPC H04L 51/046; H04L 65/403; H04L 51/34; H04L 51/10

(57) ABSTRACT

The present invention provides a technology which, by means of live streaming that freely switches between conversations with any fan, fosters the anticipation in viewers that they could be selected at any time and thus encourages more viewers to participate. Provided is an information processing system that includes a distributor terminal, a plurality of viewer terminals, and a server for performing communication with the distributor terminal and each of the plurality of viewer terminals, wherein the server is provided with: a display controlling means for displaying, on the distributor terminal, one or more candidates for a chat from among the plurality of viewers in the streaming session; a receiving means for receiving, via the distributor terminal, an operation by which the distributor indicates a chat target from among the one or more candidates; a chat controlling means for executing the chat between the viewer terminal of the chat target and the distributor terminal of the distributor; and a live streaming means for live streaming prescribed content, including the content of the chat, to each of the plurality of viewer terminals.

### TECHNICAL FIELD

The present invention relates to an information processing system.

### BACKGROUND ART

Heretofore, an information processing system has been proposed that allows people who have difficulties using information terminal functions, elderly and young people of both sexes, and people with little knowledge of the Internet to use a video live chat system with ease. A similar messaging service has previously been used as a real-time communication tool for viewers of live television broadcasts (for example, see Patent Document 1). However, to use this, candidates apply in advance by postcard, email or the like giving their contact details and are selected. Therefore, this application is unlikely to be effective as an opportunity for new viewers.

Patent Document 1: Japanese Unexamined Patent Application, Publication No. 2013-105482

### DISCLOSURE OF THE INVENTION

### Problems to be Solved by the Invention

The present invention has been made in consideration of this situation, and an object of the present invention is to provide a technology that may encourage more fans to participate in live streaming sessions.

### Means for Solving the Problems

In order to achieve the object described above, an aspect of an information processing system of the present invention includes: a distributor terminal operated by a distributor of a live stream; plurality of viewer terminals respectively operated by plurality of viewers of the live stream; and

a server that performs communication with the distributor terminal and each of the plurality of viewer terminals.
The server of this information processing system includes:
a display controlling means that displays, at the distributor terminal, one or more candidates for a chat from among the plurality of viewers of the live stream;
a receiving means that receives, via the distributor terminal, an operation by which the distributor indicates a chat target from among the one or more candidates;
a chat controlling means that executes the chat between the viewer terminal of the chat target and the distributor terminal of the distributor; and
a live streaming means that live streams prescribed content, including content of the chat, to each of the plurality of viewer terminals.

### Effects of the Invention

According to the present invention, more fans may be encouraged to participate in live streaming sessions.

### BRIEF DESCRIPTION OF THE DRAWINGS

FIG. 1 is a block diagram depicting structures of an embodiment of an information processing system according to the present invention.

FIG. 2 is a block diagram depicting a hardware configuration of a server of the information processing system in FIG. 1.

FIG. 3 is a functional block diagram depicting functional structure examples of the server, a distributor terminal and viewer terminals of the information processing system in FIG. 1.

FIG. 4 is a view depicting an example of a screen displayed at the distributor terminal of the information processing system in FIG. 1.

FIG. 5 is a flowchart describing an example of a flow of processing executed by the server with the functional structures in FIG. 3.

FIG. 6 is a diagram depicting an outline of processing to determine a priority order of chat targets by coin offer amounts, which is executed by the server with the functional structures in FIG. 3.

FIG. 7 is a view depicting an example of a screen displayed at the viewer terminal of the information processing system in FIG. 1.

FIG. 8 is a view depicting an example of a screen displayed at the viewer terminal of the information processing system in FIG. 1.

### PREFERRED MODE FOR CARRYING OUT THE INVENTION

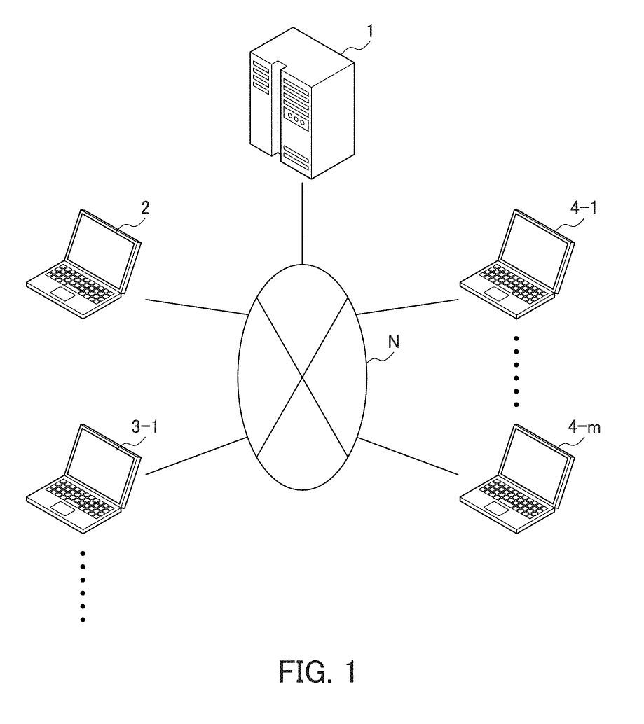

FIG. 1 is a block diagram depicting structures of an information processing system according to an embodiment of the present invention. The information processing system illustrated in FIG. 1 includes a server 1, a distributor terminal 2, guest terminals 3-1 to 3-n that are respectively used by n guests (n being an arbitrary integer that is at least 0), and viewer terminals 4-1 to 4-m that are respectively used by m viewers (m being an arbitrary integer that is at least 1). The meaning of the term “live streaming” is intended to include real-time streaming of various kinds of content including public chats. The meaning of the term “distributor” is intended to include the main party implementing a live streaming session, which in the present embodiment is a person executing a public chat with one or more viewers. In the present embodiment, the chat is a “public chat” that is live streamed both to terminals exchanging messages and the like in real time and, as images of the content of the chat, to all of the viewer terminals 4-1 to 4-m. The meaning of the term “guest” is intended to include a user specifically participating in the public chat at the invitation of the distributor. The meaning of the term “viewers” is intended to include people viewing the public chat, including chat candidates and chat targets. In the present description, the meaning of the term “chat” includes communication by exchanging messages and the like in real time between plurality of terminals over a network N. Texts, voice messages, images (still images and video images) and so forth may be used as means for communication. Chats using these means are referred to, respectively, as text chats, voice chats, video chats and so forth. In the following descriptions, a chat is assumed to be a video chat but this is not particularly limiting. The descriptions may be applied to a text chat, a voice chat or the like. The term “voice chat” may encompass telephone conversations. That is, when the network N is a carrier network managed by a cellphone carrier, a telephone conversation may be regarded as a voice chat. A video chat and a text chat may be combined, with text messages being displayed superimposed on a video image and scrolling. The server 1 is interconnected with the distributor terminal 2, each of the guest terminals 3-1 to 3-n, and each of the viewer terminals 4-1 to 4-m via the prescribed network N, which is the Internet or the like.

The server 1 provides a live streaming environment for the distributor terminal 2, each of the guest terminals 3-1 to 3-n and each of the viewer terminals 4-1 to 4-m. Below, where there is no need to individually distinguish the respective guest terminals 3-1 to 3-n, the same are referred to in general as “the guest terminals 3”. Similarly, where there is no need to individually distinguish the respective viewer terminals 4-1 to 4-m, the same are referred to in general as “the viewer terminals 4”. When the distributor wishes to add an arbitrary user to the chat, the distributor may operate the distributor terminal 2 and specifically invite a guest user. The structure of the guest terminal 3 that the guest user uses is similar to the other terminals, and therefore is not illustrated or described below.

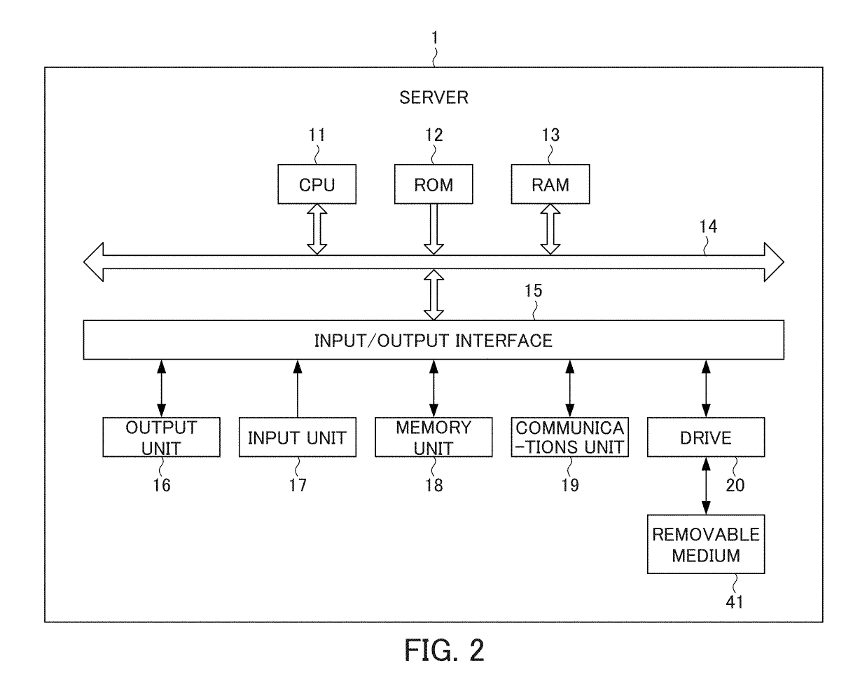

FIG. 2 is a block diagram depicting a hardware configuration of a server of the information processing system in FIG. 1. The server 1 is equipped with a central processing unit (CPU) 11, a read-only memory (ROM) 12, a random access memory (RAM) 13, a bus 14, an input/output interface 15, an output unit 16, an input unit 17, a memory unit 18, a communications unit 19 and a drive 20.

The CPU 11 executes various processes in accordance with a program stored in the ROM 12 or a program loaded into the RAM 13 from the memory unit 18. Data and suchlike that is required for the execution of various processes by the CPU 11 is stored in the RAM 13 as appropriate.

The CPU 11, the ROM 12 and the RAM 13 are connected to one another via the bus 14. The input/output interface 15 is also connected to the bus 14. The output unit 16, the input unit 17, the memory unit 18, the communications unit 19 and the drive 20 are connected to the input/output interface 15.

The output unit 16 is structured with an individual liquid crystal display or the like, and outputs various kinds of information. The input unit 17 is structured with numerous hardware buttons or the like, and inputs various kinds of information. The memory unit 18 is structured with a dynamic random access memory (DRAM) or the like, and stores various kinds of data. The communications unit 19 controls communications with other equipment (in the example in FIG. 1, the distributor terminal 2, the viewer terminal 4 and the like) via the network N, including the Internet.

The drive 20 is provided as required. A removable medium 41 constituted by a magnetic disk, an optical disk, a magneto-optical disk, a semiconductor memory or the like is installed in the drive 20 as appropriate. As required, a program read from the removable medium 41 by the drive 20 is installed in the memory unit 18. Similarly to the memory unit 18, the removable medium 41 may memorize the various kinds of data that are memorized in the memory unit 18.

Structures of the distributor terminal 2, the guest terminals 3 and the viewer terminals 4 are basically the same as the structure of the server 1, except that these structures may include touch panels. Accordingly, these structures are not described here.

The following processing may be executed by interoperation of the various hardware and software of the server 1, distributor terminal 2, guest terminals 3 and viewer terminals 4 in FIG. 2.

In the present embodiment, the server 1 selects one or more chat candidates by an arbitrary method from the viewers who are viewing a public chat at the viewer terminals 4. In accordance with a command from the distributor terminal 2, the server 1 chooses a chat target from the one or more selected chat candidates. The server 1 executes various kinds of control required for executing the public chat between the viewer terminal 4 of the chat target chosen in this manner and the distributor terminal 2, and the server 1 live streams prescribed content including the content of the chat to the viewer terminals 4 and other devices. Images captured by the viewer terminals 4 of one or more chat candidates who have not been selected as the chat target (mainly facial images of these viewers) are displayed in a list at least at the distributor terminal 2. These images may be selected by the distributor at any time. According to this mode, in a live streaming session in which the distributor is a celebrity or the like, conversation is freely switched between arbitrary fans (viewers) and the conversations are included in the live streaming session. As a result, the viewers may be inspired with anticipation that they could be selected at any time, which may encourage more fans to participate as viewers in the live streaming session.

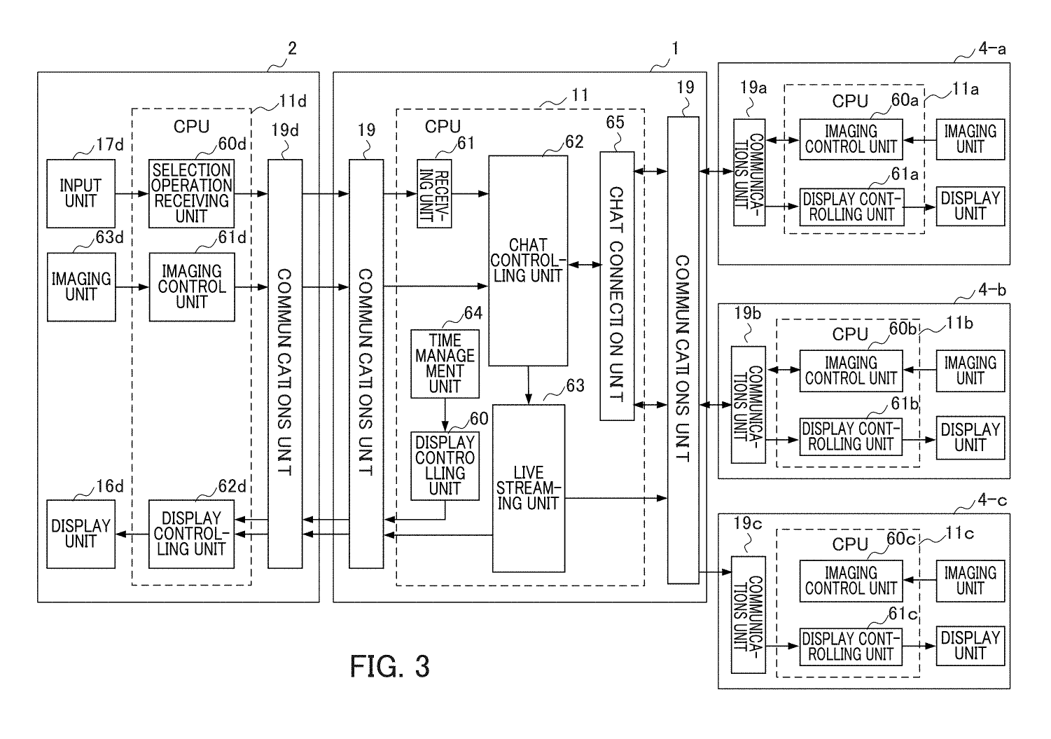

The server 1, distributor terminal 2 and viewer terminals 4 include functional structures as illustrated in FIG. 3 in order to execute a sequence of processing for live streaming a public chat as described above (below referred to as the live streaming processing). Below, of the viewer terminals 4 described above, the viewer terminal 4 being operated by a chat target is referred to as the viewer terminal 4-a (a is an arbitrary integer from 1 to m). The viewer terminal 4 of a chat candidate who is to be a subsequent chat target is referred to as the viewer terminal 4-b (b is an arbitrary integer from 1 to m that is a different integer from a), and the viewer terminal 4 of a viewer simply viewing the live streaming session who is neither the chat target or a chat candidate is referred to as the viewer terminal 4-c (c is an arbitrary integer from 1 to m that is a different integer from a and b).

FIG. 3 is a functional block diagram depicting functional structure examples of the server and user terminals in FIG. 2. The CPU 11 of the server 1 includes the functions of a display controlling unit 60, a receiving unit 61, a chat controlling unit 62, a live streaming unit 63, a time management unit 64 and a chat connection unit 65. A CPU 11d of the distributor terminal 2 includes the functions of a selection operation receiving unit 60d, an imaging control unit 61d, and a display controlling unit 62d. A CPU 11a of the viewer terminal 4-a includes the functions of an imaging control unit 60a and a display controlling unit 61a. A CPU 11b of the viewer terminal 4-b includes the functions of an imaging control unit 60b and a display controlling unit 61b. A CPU 11c of the viewer terminal 4-c includes the functions of an imaging control unit 60c and a display controlling unit 61c.

Via the communications unit 19, the display controlling unit 60 of the CPU 11 of the server 1 causes at least one chat candidate from among the plurality of viewers of the live streaming session to be displayed at a display unit 16d of the distributor terminal 2. The receiving unit 61 of the CPU 11 of the server 1 receives information identifying a chat target indicated by the distributor from the distributor terminal 2, via the communications unit 19.

On the basis of the information identifying the chat target indicated by the distributor, the chat controlling unit 62 of the CPU 11 of the server 1 identifies the viewer terminal 4-a of the chat target, and notifies the chat target of the indication via the chat connection unit 65 and the communications unit 19. The chat controlling unit 62 also sends commands to start imaging and such to the viewer terminal 4-a and the viewer terminal 4-b via the chat connection unit 65 and the communications unit 19.

The live streaming unit 63 of the CPU 11 of the server 1 sends content of the chat back and forth between the distributor terminal 2 and the viewer terminal 4-a via the communications unit 19. The live streaming unit 63 live streams prescribed content, including the content of the chat, to the distributor terminal 2 and each of the plurality of viewer terminals 4 via the communications unit 19.

When a certain duration has passed, the time management unit 64 of the CPU 11 of the server 1 gives a command to the display controlling unit 60 to update the display of the list of chat candidates. In this manner, the chat controlling unit 62 of the CPU 11 of the server 1 executes the chat between the viewer terminal 4-a of the chat target and the distributor terminal 2 of the distributor.

The chat connection unit 65 of the CPU 11 of the server 1 manages sessions for, of the viewer terminals 4, the viewer terminal 4-a of the chat target and the viewer terminal 4-b of each chat candidate. Accordingly, excessive loads on hardware resources of the server 1 such as the CPU 11 may be avoided, images and such at the viewer terminal 4-b of each chat candidate may be read in advance, and the occurrence of a connection delay when the chat target is switched to one of the chat candidates may be avoided.

The selection operation receiving unit 60d of the CPU 11d of the distributor terminal 2 receives operations to display one or more of the chat candidates and to indicate a chat target among the chat candidates. The selection operation receiving unit 60d sends information identifying the indicated chat target to the server 1 via a communications unit 19d.

The imaging control unit 61d of the CPU 11d of the distributor terminal 2 controls an input unit 17d to serve as an imaging unit 63d, and causes imaging, audio recording, keyboard entry and pointing device entry of distributor messages (this is below referred to as “imaging and such”). The imaging control unit 61d of the CPU 11d of the distributor terminal 2 sends distributor messages obtained by imaging and such to the server 1 via the communications unit 19d.

The imaging control unit 60a of the CPU 11a of the viewer terminal 4-a receives a command to start imaging and such from the server 1, controls an input unit 17a to serve as an imaging unit, and conducts imaging and such of messages from the viewer who is the chat target. The viewer terminal 4-a sends the messages obtained by imaging and such from the viewer who is the chat target to the server 1 via a communications unit 19a.

The display controlling unit 62d of the CPU 11d of the distributor terminal 2 receives the list of chat candidates, the content of the chat, and prescribed content including the content of the chat, and displays these at the display unit 16d.

The display controlling unit 61a of the CPU 11a of the viewer terminal 4-a receives the content of the chat and prescribed content including the content of the chat, and displays the same at an output unit 16a, which is a display unit. The display controlling unit 61b of the CPU 11b of the viewer terminal 4-b receives the content of the chat and prescribed content including the content of the chat, and displays the same at an output unit 16b, which is a display unit. The display controlling unit 61c of the CPU 11c of the viewer terminal 4-c receives the content of the chat and prescribed content including the content of the chat, and displays the same at an output unit 16c, which is a display unit.

The imaging control unit 60b of the CPU 11b of the viewer terminal 4-b or the imaging control unit 60c of the CPU 11c of the viewer terminal 4-c may control an input unit 17b or input unit 17c to serve as an imaging unit and conduct imaging and such of a thumbnail video image or the like of the viewer. The imaging control unit 60b or imaging control unit 60c may send the thumbnail video image of the viewer that has been conducted imaging and such to the server 1 via a communications unit 19b or communications unit 19c.

The display controlling unit 60 of the CPU 11 of the server 1 causes one or more of the thumbnail video images or the like of the chat candidates that are received via the communications unit 19 to be displayed at the display unit 16d of the distributor terminal 2 as icons. A status of each chat candidate, such as “absent”, “acquiring” or the like, may be displayed.

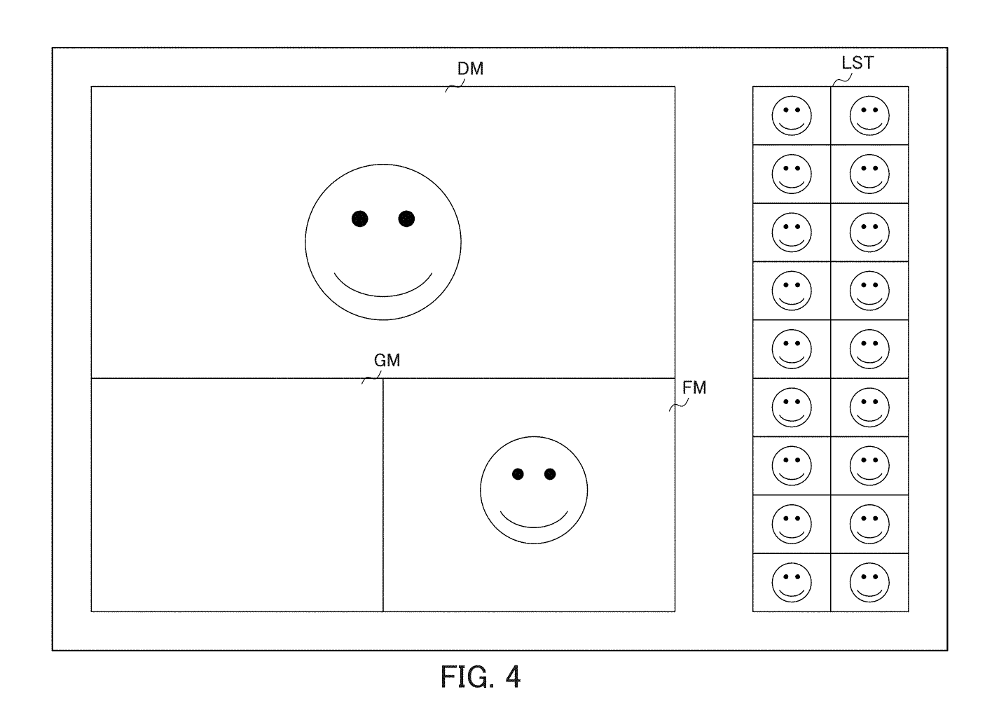

FIG. 4 is a view depicting an example of a screen displayed at the distributor terminal of the information processing system in FIG. 1. A chat candidate list display area LST in the right part of the screen in FIG. 4 individually displays each of one or more chat candidates (images imaged by the viewer terminals 4). At the distributor terminal 2, the chat candidate list display area LST functions as an operation receiving region for designating indications of chat targets. If the chat candidate list display area LST is also displayed at the viewer terminals 4 in a live streaming session, it is simply a display region. An operation to indicate a chat target may be performed by tapping the display area of one person in the chat candidate list display area LST. In this manner, the distributor may switch between chat targets. In addition, chat targets may be added or removed.

The chat candidates who are displayed in the chat candidate list display area LST may be replaced by a scrolling operation at the distributor terminal 2. Thus, a greater number of chat candidates may be displayed than the number that can be displayed at one time. By a prescribed operation at the distributor terminal 2, the chat candidates in the chat candidate list display area LST may be sorted in a desired order of priority. That is, the display controlling unit 60 may cause the chat candidates to be displayed in an order based on a result of editing from the distributor terminal 2.

The display controlling unit 60 displays the statuses of the chat candidates (for example, statuses such as on-line, off-line and the like) near the images of the chat candidates that are displayed in the chat candidate list display area LST.

The distributor may perform prescribed operations at the distributor terminal 2 and, in accordance with control of the display controlling unit 60, the chat candidates displayed in the chat candidate list display area LST may be displayed categorized by or sorted in order of respective attributes. For example, the display controlling unit 60 may sort the chat candidates by areas of residence or sort the chat candidates by age groups.

In a distributor message display area DM in the upper-left region of the screen in FIG. 4, an image imaged by the imaging unit of the distributor terminal 2 and such is displayed (generally, a facial image of the distributor, a text image of a comment made by the distributor or the like). In a chat target message display area FM in the lower-middle region of the screen in FIG. 4, a chat target image imaged by the imaging unit of the viewer terminal 4-a and such is displayed (generally, a facial image of the chat target, a text image of a comment made by the chat target or the like).

If the distributor has invited a guest user, a guest user message display area GM in the lower-left region of the screen in FIG. 4 displays an image imaged by the imaging unit of the guest terminal 3 and such (generally, a facial image of the guest, a text image of a comment made by the guest or the like). In a situation in which the distributor has not invited a user as a guest, the guest user message display area GM may be reduced or removed. Accordingly, the other display areas may be displayed larger. All or some of the screen in FIG. 4 is streamed as the live stream and displayed at the viewer terminal 4-b. Thus, when, for example, a celebrity or the like is performing a live stream in the role of the distributor, the distributor may freely switch conversation between arbitrary fans (viewers) and include the fans in the live streaming session. Therefore, the viewing fans may be inspired with anticipation that they could be selected at any time.

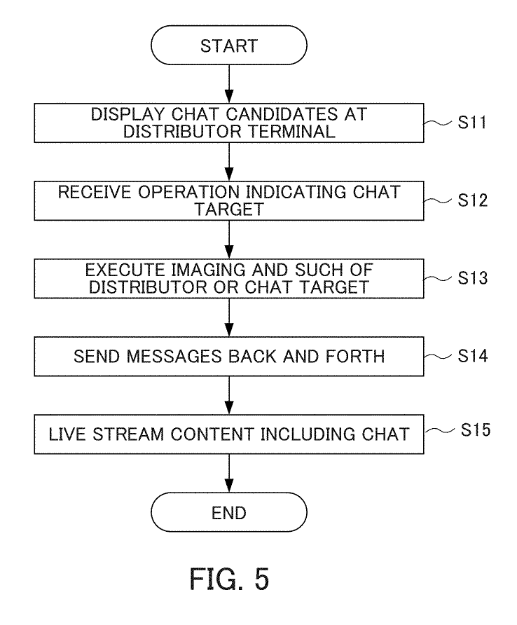

FIG. 5 describes an example of a flow of processing executed by the server with the functional structures in FIG. 3. The following sequence of processing is executed at the server 1 as the live streaming processing.

In step S11, the display controlling unit 60 displays a list of chat candidates selected by an arbitrary method at the distributor terminal 2. In step S12, the receiving unit 61 receives an operation indicating a chat target.

In step S13, the chat controlling unit 62 causes imaging and such of each of the distributor at the distributor terminal 2 and the chat target at the viewer terminal 4-a.

In step S14, the chat controlling unit 62 sends messages providing results of imaging and such back and forth between the distributor terminal 2 and the viewer terminal 4-a. Chatting is executed between the distributor and the chat target by the processing of steps S13 and S14. In step S15, the server 1 executes live streaming of content including the chat.

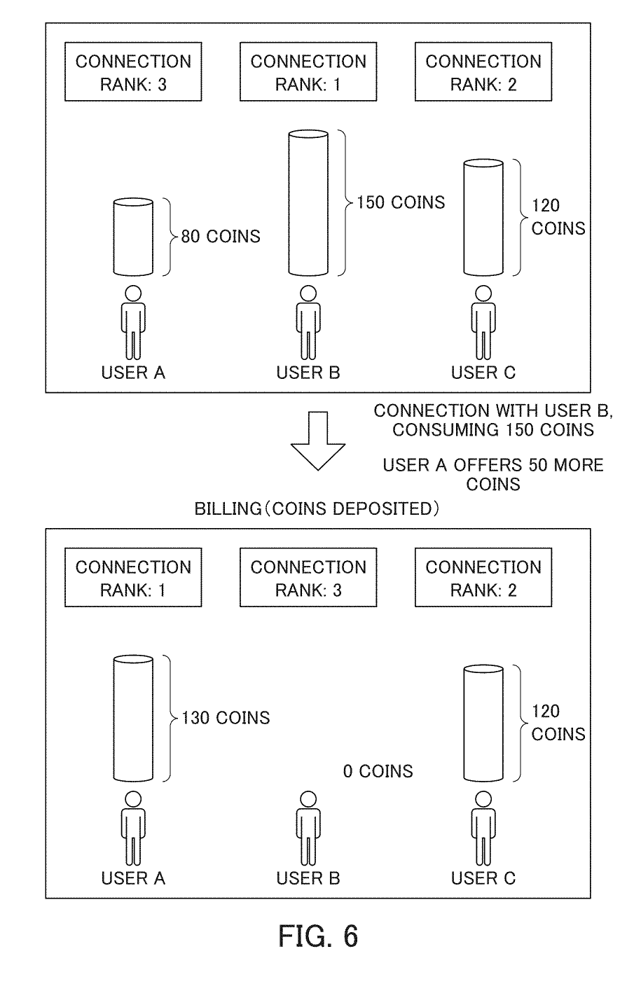

FIG. 6 is a diagram depicting an outline of processing to determine a priority order for selection of a chat target by coin offer amounts, which is executed by the server with the functional structures in FIG. 3. An information system according to an embodiment of the present invention may charge fees by selling virtual coins in the system.

Accordingly, viewers who want to enjoy chatting with the distributor may offer greater numbers of coins, making their wish to engage in the chat more likely to be fulfilled. Meanwhile, the distributor (the celebrity or the like who is conducting the chat) can easily see the amount of coins offered by each viewer. Thus, the distributor may easily understand and decide who they will chat with next.

FIG. 6 illustrates a situation in which, in the information system according to the embodiment of the present invention, each of a user A, a user B and a user C, who are viewers wanting to be selected as the chat target, offers coins in order to rise in priority for selection as the chat target. The upper part of FIG. 6 illustrates an initial state in this situation. User B has offered 150 coins in the system and has first priority for selection as the chat target, user C has offered 120 coins in the system and has second priority for selection, and user A has offered 80 coins in the system and has third priority for selection.

If user B, who has first priority, is selected as the chat target and user A, who has not been selected as the chat target, offers an additional 50 coins, the state becomes as illustrated in the lower part of FIG. 6. That is, user A has now offered a total of 130 coins in the system and has first priority for selection as the chat target, while user C has offered 120 coins in the system and has second priority for selection. All of the 150 coins offered by user B who has been selected as the chat target are consumed, user B's coin offer amount has returned to zero, and user B has third priority for selection.

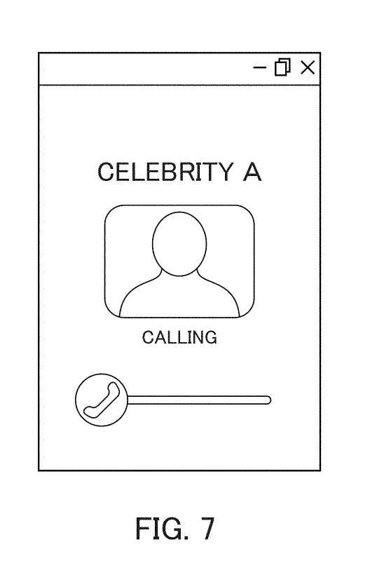

FIG. 7 is a view depicting an example of a screen displayed at a viewer terminal in the information processing system according to the embodiment of the present invention. When the information processing system according to the embodiment of the present invention starts a live streaming session of prescribed content including a chat, a screen similar to a screen representing a state in which a telephone call is incoming from the distributor of the live session is displayed at each of predetermined viewer terminals.

FIG. 7 is an example of the display screen at the viewer terminal in this state, in which the start of the live streaming session is notified in a timely manner through the display of the screen similar to a display for when an ordinary phone call is incoming. For example, a symbol enabling a swipe operation that depicts a handset is displayed together with a personal name, by which the distributor of the live streaming session is known, as the origin of the call.

The viewer of this screen may start viewing the live streaming session by an operation similar to a swipe operation that is performed to answer an ordinary phone call. This function may be relatively easily implemented with a telephone function integrated development environment provided by the maker of the terminal or the like.

In this manner, the viewer may start viewing quickly and easily, skipping standard operations for viewing such as a lock release operation that is required when the viewer starts operating the viewer terminal, an application launch operation and so forth. Therefore, even if the viewer is made aware of the imminent start of live streaming at a time just before the streaming session by a call tone, incoming call vibration or the like, the viewer may reliably start viewing of the live streaming session at substantially the same time as the streaming session starts.

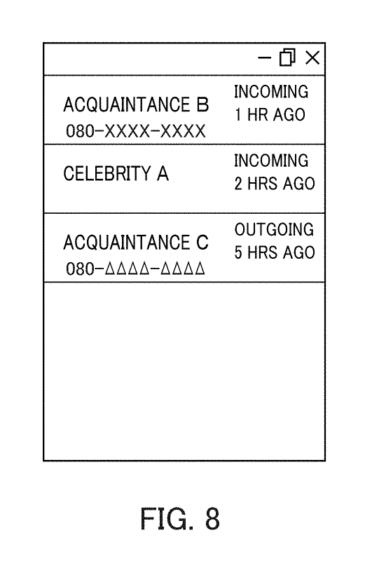

FIG. 8 is a view depicting an example of a screen that is displayed at a viewer terminal in the information processing system according to the embodiment of the present invention. As described above, the information processing system according to the embodiment of the present invention gives notice of the start of live streaming by displaying an incoming call screen similar to a screen if a phone call for a conversation was arriving from the distributor of the live session.

This information processing system causes a call history to be memorized in the viewer terminal or the like, which is similar to a call history of a phone call for a conversation arriving from the distributor of the live streaming session. FIG. 8 is an example of an incoming call history display screen at the viewer terminal in this situation. The viewer may, by performing ordinary browsing operations in the incoming call history, see live streaming sessions that the viewer has viewed or missed and notices of the start of live streaming sessions.

Accordingly, when the viewer is using call functions of the viewer terminal without particular intent, the viewer's attention may be drawn to a subsequent live streaming session.

An embodiment of the present invention is described hereabove, but the present invention is not limited by the embodiment described above. The effects recited in the present embodiment are merely an enumeration of the most preferable effects produced by the present invention. Effects provided by the present invention are not limited to the effects recited in the present embodiment.

For example, the server 1 and the viewer terminals 4 may be configured to enable operations to add and remove decorative effects as seen in, for example, “photo sticker (Purikura)” images to and from the images imaged by the imaging units, which are generally facial images, that are displayed in the chat candidate list display area LST and the chat target message display area FM. Modes of decorative effects may include: a graffiti effect for superimposing a handwritten message; a big-eye effect for making the eyes appear much larger; a dark skin effect or fair skin effect for changing the hue of the skin to very dark or very fair; a beautiful-skin effect for removing bruises, pimples, moles, insect bites and the like; a small-face effect for making the face appear smaller; a funny-face effect that changes the facial expression; a wig effect that changes the hairstyle and hair color; a cosplay effect that changes clothing; an animal effect that adds animal parts such as eyes and a nose; an eye-masking effect that hides the eyes with a bar in order to protect privacy; a child effect that makes the face appear babyish; an ageing effect that makes the face appear elderly; a robot effect that makes the face look like a robot; a fattening effect that makes the face appear wider; a slimming effect makes the face appear thinner; a character effect that makes the face look like a cartoon character; a cosmetic effect that adds cosmetics; a glasses effect that adds spectacles, a tough-face effect that adds scars and tattoos; and so forth.

The server 1 and viewer terminals 4 may be configured to enable operations to indicate and display video or still images of avatars and the like instead of the aforementioned facial images. Accordingly, the desires of viewers to not have their faces publicly shown, to stand out in a battle to become the chat target, to make a strong impression and be memorable when selected as the chat target, and so forth may be satisfied. A terminal similar to the distributor terminal 2 may be added, to enable a staff member other than the distributor to perform operations to sort the chat candidates displayed in the chat candidate list display area LST.

As mentioned above, the list of chat candidates displayed in the chat candidate list display area LST is updated when a certain duration has passed. The distributor terminal 2 may be equipped with a vibration function that, by physically oscillating the distributor terminal 2 or oscillating the display screen, notifies the distributor operating the distributor terminal 2 shortly before (for example, 30 seconds before) the chat candidates displayed in the current list of candidates are to be sorted. Accordingly, the distributor may take the vibration as a prompt to sort the chat candidates earlier.

In the selection of chat candidates, weightings based on age may be applied in determining the priority order, such that a particular age group may be displayed with priority. Accordingly, for example, if the chat topic is a movie or the like about the lives of young workers, candidates in an age group who are likely to be closely involved with the topic may be displayed in the list.

As mentioned above, operations to purchase coins in order to be displayed with priority and operations to offer the purchased coins may be enabled at the viewer terminals 4, and weightings according to the values of the offered coins may be applied by the server 1 in determining the priority order.

Weightings based on viewing duration may be applied in determining the priority order such that, of all the viewers viewing the viewer terminals 4, viewers who have been viewing for longer times are displayed with priority. Alternatively, coins may be awarded in accordance with viewing durations; whether or not to offer these coins back is left to the discretion of the viewers. A viewing duration may mean a duration of continuous viewing without switching to another channel.

The coins obtained by purchases and awards may be provided with expiration dates such that any coins a viewer does not use (does not offer) over a long period expire. In this manner, the viewers are encouraged to actively make use of the coins rather than doing nothing and hoarding the coins.

When a viewer is not selected as the chat target, offered coins are not consumed. When a viewer is selected as the chat target, the offered coins may be consumed in accordance with how long the chat continues.

The rate of coin consumption during the chat may be adjusted such that the greater the amount of coins offered, the faster the consumption rate. In this manner, while the wishes of viewers who are happy to pay money to become the chat target may be satisfied, a situation in which only wealthy viewers are favored may be avoided; even students and the like with meager resources may have a chance to become the chat target for at least some time.

An operation by the distributor or the like to select a chat target may be a tap operation in the chat candidate list display area LST, or a swipe operation in the chat candidate message display area FM may be employed. For example, when the distributor swipes right in the chat candidate message display area FM, a chat candidate displayed in the chat candidate list display area LST at the right side of the current chat target is selected.

In response to a vertical or horizontal swipe operation in the chat candidate list display area LST, the displayed chat candidates may be replaced by scrolling. Thus, the distributor may preview peripheral candidates outside the display. In this manner, scrolling of the chat candidate list display area LST may smoothly track swipe operations.

The display unit of the viewer terminal 4-b may display the number of chat candidates who are currently ahead in line according to the priority order.

Selection as a chat candidate may be simultaneously notified to each viewer terminal 4-b; subsequently, a response may be prompted to agree to becoming the chat target or to refuse. In this case, the priority order may be the order of agreement responses at the viewer terminals. Alternatively, a round number in the response order such as the 100th person to respond, or another significant number or the like, may be given first priority.

The priority order may give precedence to followers, registered users of a fan site, and the like.

When the number of chat candidates is small because many chat candidates have successively been the chat target, a candidate addition selection display for selecting additional chat candidates may be displayed at the distributor terminal 2 or the like.

The hardware structures depicted, for example, in FIG. 2 are merely an illustration for achieving the object of the present invention and are not particularly limiting.

Furthermore, the functional block diagram depicted in FIG. 3 is merely an illustration and is not particularly limiting. That is, it is sufficient if functions capable of executing the whole of the above-described sequence of processing are provided in the information processing system. The kinds of functional blocks to be used for executing these functions are not particularly limited by the example in FIG. 3.

Moreover, the locations of functional blocks are not limited by FIG. 3 and may be arbitrary. For example, one or more of the functional blocks at the server 1 may be provided at the distributor terminal 2, and vice versa. A single functional block may be constituted by a hardware unit, and may be constituted by a combination with a software unit.

As an example, the distributor terminal 2 is constituted by a personal computer in the embodiment described above. However the distributor terminal 2 may be arbitrary equipment encompassing not just computers but also tablets and novel devices developed in the future.

In a case in which the processing of the functional blocks is to be executed by software, a program configuring the software is installed from a network or a storage medium into a computer or the like. The computer may be a computer embedded in dedicated hardware. Alternatively, the computer may be a computer capable of executing various functions by installing various programs. For example, as an alternative to a server, the computer may be a smartphone, a personal computer or the like.

As well as a removable medium that is distributed separately from the main body of the equipment for supplying a program to users, a recording medium with the program may be constituted by a recording medium or the like that is supplied to users incorporated in the main body of the equipment.

The steps in the present specification describing the program recorded in the storage medium encompass not only processing executed to follow the sequence of steps chronologically, but also processing that is not necessarily executed chronologically but is executed in parallel or separately.

To summarize the above, an information processing system in which the present invention is employed may encompass a variety of embodiments provided the following structure is provided.

That is, it is sufficient that an information processing system in which the present invention is employed includes: a distributor terminal (for example, the distributor terminal 2) operated by a distributor of a live stream (a celebrity or the like); plurality of viewer terminals (for example, the viewer terminals 4-1 to 4-m) respectively operated by plurality of viewers of the live stream; and a server (for example, the server 1) that performs communication with the distributor terminal and each of the plurality of viewer terminals, and that the server includes: a display controlling means (for example, the display controlling unit 60 in FIG. 3) that displays, at the distributor terminal, one or more candidates for a chat from among the plurality of viewers of the streaming session; a receiving means (for example, the receiving unit 61 in FIG. 3) that receives, via the distributor terminal, an operation by which the distributor indicates a chat target from among the one or more candidates; a chat controlling means (for example, the chat controlling unit 62 in FIG. 3) that executes the chat between the viewer terminal of the chat target and the distributor terminal of the distributor; and a live streaming means (for example, the live streaming unit 63 in FIG. 3) that live streams prescribed content, including content of the chat, to each of the plurality of viewer terminals.

When this information processing system is employed, a technology may be provided that encourages a greater number of fans to view a live stream.

### EXPLANATION OF REFERENCE NUMERALS

1 Server, 2 Distributor terminal, 3-1 to 3-n Guest terminals, 4-1 to 4-m Viewer terminals, 4-a Chat target viewer terminal, 4-b Viewer terminal (chat candidate), 4-c Viewer terminal (chat candidate/non-candidate), 11 CPU,12 ROM, 13 RAM, 14 Bus, 15 Input/output interface, 16 Output unit, 17 Input unit, 18 Memory unit, 19 Communications unit, 20 Drive, 41 Removable medium, 60 Display controlling unit, 61 Receiving unit, 62 Chat controlling unit, 63 Live streaming unit, 64 Time management unit, 65 Chat connection unit, 60d Selection operation receiving unit, 61d Imaging control unit, 62d Display controlling unit, 60a Imaging control unit, 61a Display controlling unit, 60b Imaging control unit, 61b Display controlling unit, 60c Imaging control unit, 61c Display controlling unit, LST Chat candidate list display area, DM Distributor message display area, FM Chat target message display area, GM Guest user message display area, N Network

1. An information processing system comprising: a distributor terminal operated by a distributor of a live stream;
a plurality of viewer terminals respectively operated by a plurality of viewers of the live stream; and
a server that performs communication with the distributor terminal and each of the plurality of viewer terminals,
wherein
the server includes:
a display controlling means that displays, at the distributor terminal, one or more candidates for a chat from among the plurality of viewers of the live stream;
a receiving means that receives, via the distributor terminal, an operation by which the distributor indicates a chat target from among the one or more candidates;
a chat controlling means that executes the chat between the viewer terminal of the chat target and the distributor terminal of the distributor; and
a live streaming means that live streams prescribed content, including content of the chat, to each of the plurality of viewer terminals.

2. The information processing system according to claim 1, wherein the display controlling means sorts and displays the candidates for the chat categorized by or sorted in order of respective attributes.

3. The information processing system according to claim 1, wherein the display controlling means displays the candidates for the chat in an order based on a result of editing from the distributor terminal.

4. The information processing system according to claim 1, wherein the display controlling means displays statuses of the candidates for the chat near images of the candidates for the chat.

5. The information processing system according to claim 1, the information processing system further comprising
a guest terminal operated by a guest invited to the chat by the distributor of the live stream,
wherein the chat controlling means executes the chat between the viewer terminal of the chat target, the distributor terminal of the distributor and the guest terminal.

6. The information processing system according to claim 1, wherein, before commencing live streaming of the prescribed content including the content of the chat, the live streaming means causes a screen representing a state in which a call is being received from the distributor of the live stream to be displayed at each of the plurality of viewer terminals, and causes the occurrence of the call from the distributor of the live stream to be recorded in history information at each of the plurality of viewer terminals.
